(19) United States
(12) Patent Application Publication
(10) Pub. No.: US 2026/0357914 A1
(43) Pub. Date: Nov. 12, 2026

(54) ADDITIVELY MANUFACTURED STRUCTURES FOR PRESSURE RELIEF OF IRRADIATION CAPSULES

(71) Applicant: UT-Battelle, LLC, Oak Ridge, TN (US)

(72) Inventors: Frederick A List, III, Oak Ridge, TN (US); Richard H. Howard, Knoxville, TN (US); James K. Carver, Oak Ridge, TN (US); Thomas Butcher, Oak Ridge, TN (US); Chase B. Joslin, Madisonville, TN (US)

(73) Assignee: UT-Battelle, LLC, Oak Ridge, TN (US)

(21) Appl. No.: 19/638,940

(22) Filed: Apr. 3, 2026

Related U.S. Application Data
(60) Provisional application No. 63/801,934, filed on May 8, 2025.

(51) Int. Cl. F16K 17/40

(52) U.S. Cl. CPC F16K 17/403

(57) ABSTRACT

A pressure-actuated rupture device includes a rigid cap that resists deformation and distributes pressure-induced forces from a working fluid, coupled through a stiff, mandrel central core to a base. A deformable member cylindrical side wall surrounds the core and is designed with a tunable ultimate strength threshold below a yield strength level of a receiving device. A buttress element with an inclined surface connects to a vertical element and to the base and redirects axial forces into lateral forces that act on the deformable member. A surrounding regulator zone, formed as a cylindrical annular space, helps control the force distribution and deformation behavior. These components are concentrically arranged about a common axis of symmetry, and the thickness of the deformable wall has an ultimate strength level that is below the yield strength level of an associated receiving structure.

### 2. PRIORITY CLAIM

This application claims the benefit of priority from U.S. Provisional Application No. 63/801,934, filed on May 8, 2025, titled “Additively Manufactured Structures for Pressure Relief of Irradiation Capsules”, which is incorporated herein by reference in its entirety.

### 1. STATEMENT REGARDING FEDERALLY SPONSORED RESEARCH & DEVELOPMENT

These inventions were made with United States government support under Contract No. DE-AC05-00OR22725 awarded by the United States Department of Energy. The United States government has certain rights in the inventions.

### 3. TECHNICAL FIELD

This application relates to additive manufacturing and specifically to the additive manufacture of pressure limiting devices.

### 4. RELATED ART

Over-pressurization affects many industrial systems. When operating pressures exceed design their limits, the failures may lead to catastrophic consequences. Unlike normal operating conditions, over-pressure events can occur without warning.

When excessive pressure occurs, seals may fail, hoses may burst, and metal vessels may deform or rupture. In nuclear systems, when vessels deform a wall's movement may restrict the flow of coolant causing a thermal run-away condition in a reactor's core. In hydraulic systems, it may cause high-velocity fluid escape causing immediate damage to sliding surfaces.

Over-pressurization may manifest as leakages at flanges, gaskets, and vessels resulting in a loss of containment. Containment loss may damage surrounding equipment and cause progressive failures that trigger chain reactions and cascade failures.

### DESCRIPTION OF THE DRAWINGS

The figures are not necessarily to scale; emphasis instead being placed upon illustrating the principles of the invention. Moreover, in the figures, like-referenced numerals designate corresponding parts throughout different views.

FIG. 1 is a cross sectional side view of a pressure actuated rupture device.

FIG. 2 is an isometric view of the pressure actuated rupture device.

FIG. 3 is a top view of the pressure actuated rupture device.

FIG. 4 is an exemplary additive manufacturing process.

FIG. 5 is an exemplary receiving device.

FIG. 6 is an exemplary assembly sequence coupling the receiving device to the pressure actuated rupture device.

FIG. 7 is an isometric view of the pressure actuated rupture device after a rupture.

FIG. 8 is a cross-sectional view of a progressive deformation of a deformable member where the pressure actuated rupture device is thermally fused to a receiving device.

FIG. 9 is a cross-sectional view of a progressive deformation of the deformable member where a pressure actuated rupture device and a receiving device are formed as a single, unitary structure.

FIG. 10 an additive manufacturing system.

FIG. 11 show alternative mediated-pressure transfer deformable members.

FIG. 12 is a graph of burst pressures of pressure actuated rupture devices monolithically integrated with receiving devices that compares tall and medium axial lengths.

### DETAILED DESCRIPTION

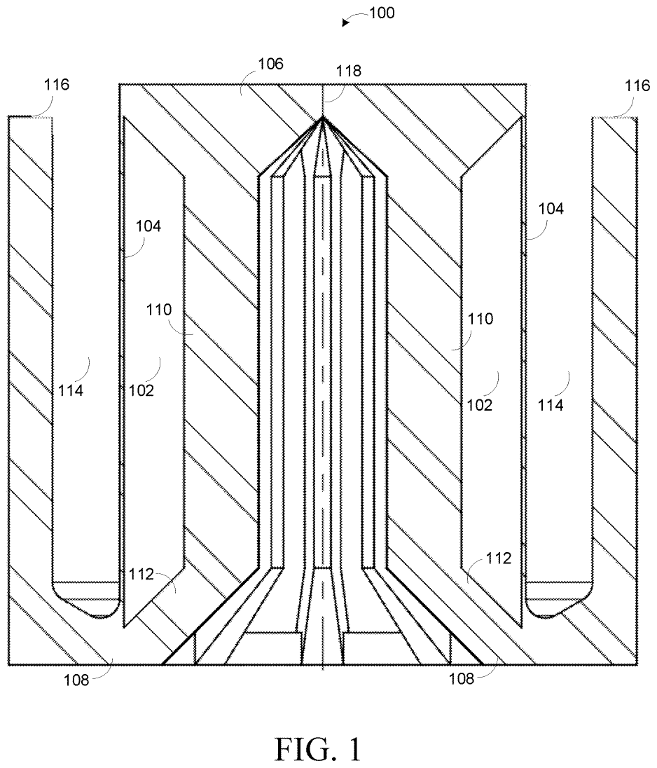

A mediated-pressure transfer system within a pressure actuated rupture device 100 of FIG. 1 includes rigid supports 110 and a deformable member 104 that confines working fluid and mediates pressure. The system shapes the pressure distribution from a source below the base 108 to a regulator zone 102 adjacent to a deformable member 104. A regulator zone pressure may cause an irreversible physical displacement of the deformable member 104 that causes predictable failures that extend into a containment zone 114.

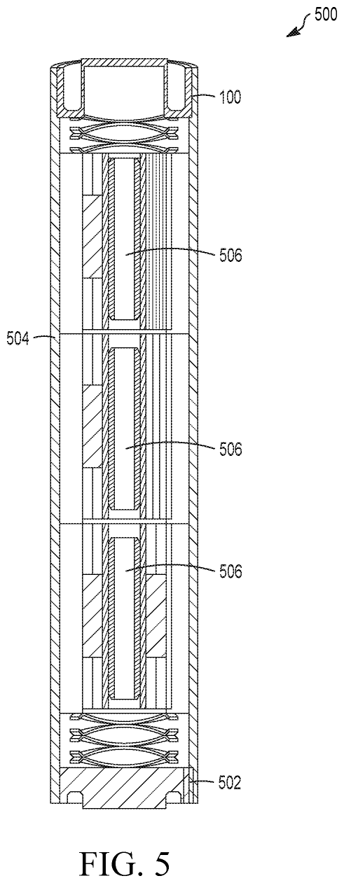

The pressure actuated rupture device 100 includes a right circular cylinder plane or disc in the form of a cap 106 and a base 108 that seal, protect, and secure the mediated-pressure transfer system and establish an upper and intermediate boundary of the pressure actuated rupture device 100. The cap 106 and base 108 are rigid boundaries that resist deformation and are part of a load-bearing structure. The cap 106 resists upward deformation and distributes forces downward or away from the cap 106, while the base 108 coaxially couples a receiving device 500 at an open end. The receiving device 500 may have a predetermined axial length like a capsule shown in FIG. 5 or be a vessel that has a tubular shape and rigid housing walls of a predetermined thickness and a predetermined diameter, for example. In some pressure actuated rupture devices 100, the inner tubular diameter of the receiving device 500 is about equal to or greater than a fixed or a variable outer diameter of the base 108 to facilitate assembly.

A central core comprises a vertical element 110 and a buttress element 112 in FIG. 1 couples the cap 106 to the base 108 to maintain alignment and a regulator zone 102 symmetry. In FIG. 1, the central core maintains its original rigid shape under its elastic limit and ensures that the pressure-induced loads are transferred to the regulator zone 102 between the central core and an interior surface of the deformable member 104 to mitigate inward bowing, protrusions, and/or deformations when operating in a stable state. The central core transfers some of the radial forces in the regulator zone 102 into biases of the deformable member 104. In this context, the term rigid refers to a component having a high modulus of elasticity (E), meaning it possesses a higher resistance to elastic deformation or stiffness than the deformable member 104, allowing it to maintain or return to its original shape, position, or volume despite being subject to high pressure, stress, and/or bending forces from the working fluid that may cause the deformable member 104 to fail (e.g., loses its barrier function). In some applications, a high modulus of elasticity of a cap 106, a base 108, and/or a central core may comprise a Young's modulus on the order of about 200 gigapascals or greater for steels that exhibit a high stiffness and minimal elastic deformation under pressure-induced loads.

The term “compliance” (C or 1/E) refers to a measure of how much a material or structure deforms in response to the working fluid forces or pressure. It measures the amount of deformation and how much the deformable member 104 material will move under a given pressure-induced load. The term “working fluid” refers to the medium and its derivatives being regulated by the pressure actuated rupture device 100. It is the medium that acts upon the mediated-pressure transfer system that includes the deformable member 104.

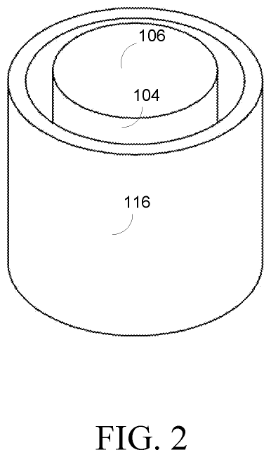

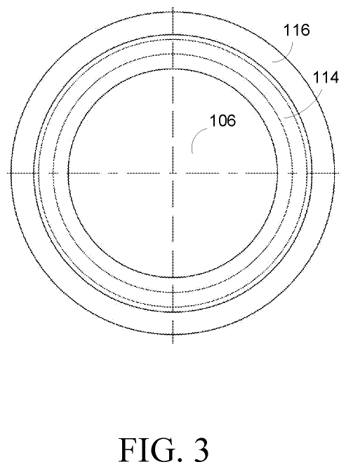

In FIGS. 1-3 the deformable member 104 comprises an additively manufactured membrane that swells, bows, and/or may rupture or burst at predetermined pressure levels to protect the receiving device 500, the other components of the mediated-pressure transfer system, and/or the system the pressure actuated rupture device 100 is operating in or within. The deformable member 104 separates the working fluid from the containment zone 114 that lies between the deformable member 104 and a containment member 116 structured to contain debris if/when a deformation, rupture, or burst of the deformable member 104 occurs.

As internal pressure increases in the receiving device 500, the pressures of the working fluid and/or its derivatives (collectively referred to as the working fluids) are directed to the deformable member 104 through the vertical element 110 and the buttress element 112 of the cap 106 support, allowing the working fluid to exert radial forces against the deformable member 104. This condition may cause the deformable member 104 to permanently bulge outward when its elastic limit is exceeded. A permanent bulge outward displaces the deformable member 104 into the containment zone 114 in an intermediate failure mode when its yield strength level is exceeded. The vertical 110 and buttress 112 elements support the cap, resist the axial forces of the working fluid on the cap, and allow the radial forces of the working fluid to displace the deformable member 104 outward into the containment zone 114.

In a stable operating mode, the cap 106 and deformable member 104 of FIGS. 1-4 have a constant circular cross-section forming a shell annulet within the regulator zone 102 and around the vertical 110 and buttress 112 elements of the cap support. The regulator zone 102 comprises an interior regulatory right-cylindrical annulet or annulet-like zone encircling the vertical 110 and the buttress 112 elements. The containment zone 114 comprises an environmentally exposed exterior containment right-cylindrical annulet or annulet-like zone encircling the deformable member 104, the regulator zone 102, the vertical element 110, and the buttress element 112. The deformable member 104 comprises a right-circular cylindrical, or cylindrical-like membrane that has a tunable yield strength level and/or a tunable ultimate strength level. It encircles the regulator zone 102, the vertical element 110, and the buttress element 112. In some exemplary devices, the shell annulet, the regulator right-cylindrical annulet or annulet-like zone, the containment right-cylindrical annulet or annulet-like zone, the vertical element 110, the buttress element 112, the deformable member 104, and the base 108 are concentric about an axis of symmetry 118. In FIGS. 1-4, the deformable member 104 mechanical properties are tunable by its geometry and the properties of the material from which it is made, collectively referred to as the deformable member parameters. The geometry of the deformable member 104 refers to its physical thickness, its physical width, its physical length, and/or its physical shape. The deformable member parameters establish the deformable member 104 resistance to elastic/plastic deformation. A physical thickness is the difference between the inner and outer surfaces, a physical diameter is the radial span, and a physical height is the axial span from the cap 106 and the base 108. All three physical properties can be adjusted, controlled, and/or tuned.

Adjacent to the deformable member 104 are the buttress element 112 and the vertical element 110 that collectively provide rigid structural support for the cap 106. The elements resist both outward axial forces on the cap from the pressure of the working fluid and inward axial forces on the cap associated with incidental handling and placement. They also allow the pressure of the working fluid to efficiently distribute in the regulator zone 102.

The deformable member 104 comprises the failure element of the mediated-pressure transfer system that is structured to fail prior to predetermined yield strength levels of a receiving device 500. The deformable member parameters are each and collectively adjustable and tunable. In some systems, one or more of the deformable member 104 parameters are tunable to a predetermined elastic limit level that establishes the maximum stress the receiving device 500 may experience while still returning the receiving device 500 completely to its original shape once the pressure-induced load is removed. In some systems, one or more of the deformable member 104 parameters are adjustable and tunable to rupture or burst the deformable member 104 at pressure levels below a yield strength of the receiving device 500 that establish the pressure-induced stress at which the receiving device 500 begins to undergo permanent deformation and will no longer return to its original shape after the pressure-induced load is removed. In some alternative systems, one or more of the deformable member 104 parameters are adjustable and tunable to rupture or burst the deformable member 104 at pressure levels below an ultimate strength of the receiving device 500 that establish the maximum pressure-induced stress at which the receiving device 500 can withstand before the receiving device 500 ruptures or bursts.

Once a stress level of the deformable member 104 exceeds its elastic limit, the deformable member 104 undergoes a permanent, plastic deformation, bulging, and/or bowing during an intermediate failure mode, and/or rupturing into the containment zone 114 during a full failure mode. This single-use, non-reclosing safety fuse-like function of the deformable member 104 prevents catastrophic failure of the receiving device 500, and in some applications, prevents failures of surrounding devices by containing the initial debris of the rupture or burst in the containment zone 114.

In a use case, the mediated-pressure transfer system may transition from a stable operating mode in which the boundaries of the pressure actuated rupture device 100 are within elastic limits. As pressure increases, the working fluid transmits more axial force toward the cap 6 and more radial force to the interior surface of the deformable member 104 through the regulator zone 102. As the system transitions to an intermediate failure mode, the radial force may gradually increase causing the deformable member 104 to undergo permanent deformation until an ultimate strength level of the deformable member 104 is exceeded. A full failure mode occurs when the yield strength level of the receiving device 500 is approached resulting in a single-use, non-returning burst or rupture in the deformable member 104. When a burst or a rupture occurs, the mediated-pressure transfer system mitigates the failure by initially containing the debris of the burst or the rupture in the containment zone 114.

The cap 106 and base 108 provide structural rigidity and are supported by the vertical 110 and buttress 112 elements, which facilitate the distribution of pressure of the working fluid within the regulator zone 102. The deformable member 104 converts pressure loads into mechanical displacement and functions like a displacement multiplier during the intermediate failure mode when bowing, swelling, and/or deformation occurs. Its deformation increases the functional surface area of the deformable member 104 and alters the pressure-induced load transfer on to it, causing a given pressure to generate a greater displacement on adjacent areas of the deformable member 104. The containment member 116 contains failure debris during a full failure mode and shields the fragile deformable member 104 from external forces that may damage the deformable member 104 during its stable operating mode. The terms bowing and swelling indicate a section of the deformable member's wall extending beyond the deformable member's 104 wall position during stable operating states.

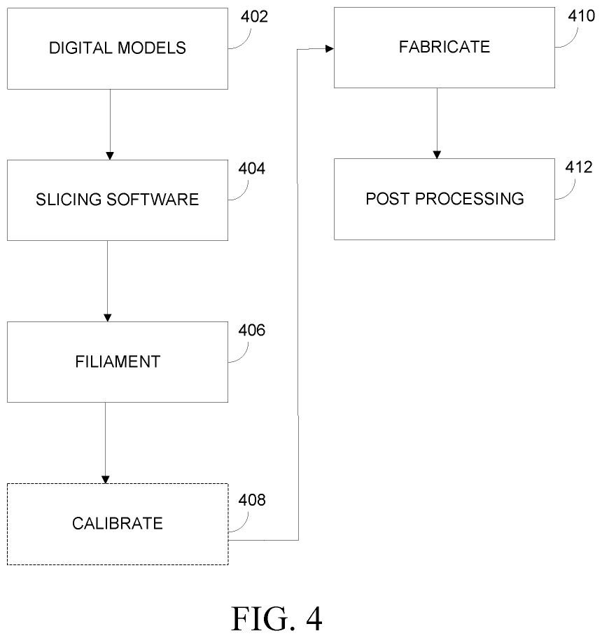

To achieve micro-precisions measurements and/or sub-micron tolerances (e.g., μm or 10⁻⁶ m) in some pressure actuated rupture devices 100 a fused deposition modeling (FDM) processes may be used as shown in FIG. 4. The first step in the additive manufacturing process is to create digital models of the pressure actuated rupture device 100 at 400. Computer Aided Design (CAD) software 1016 may be used to generate detailed three dimensional digital models 1014 and multi-dimensional drawings 1018 of the pressure actuated rupture device 100. The detailed three dimensional models 1014 are then processed by a slicing software 1020 at 404, which generates non-planar and/or curved tool paths that follow the shape of the pressure actuated rupture device 100. The slicing software 1020 accounts for multiple degrees of freedom of a print head and/or build plate or platform of a five-dimensional printer 1028 (e.g., 5-axis refers to movement and rotation during printing) such as the rotation and tilt of the printhead and/or build plate or platform. The slicing software 1020 generates machine-readable instructions 1030 stored in memory 1012 that dictate the print-head's movement, speed, and material extrusion rates.

A composite filament, such as a steel-filled filament, for example, may be loaded into the additive manufacturing printer 1028 at 406 before the additive manufacturing printer 1028 is calibrated at 408. Calibration parameters 1024 may include leveling instructions for the build plate or platform of the printer 1028 and its printhead, variable and/or fixed adjustments to the precise extrusion parameters, nozzle diameters, extrusion layer heights, extrusion rates, etc.

During fabrication, the filament is heated and extruded through the printer nozzle, depositing material along preprogrammed paths. Rather than depositing filaments in a layer-by-layer process in a post-stacked plane as many fused deposition modeling processes, the disclosed nozzle moves continuously along three-dimensional trajectories, adjusting the printhead and in some instances build plate orientation as the printer 1028 prints rather than following a raster pattern that are used in some conventional manufacturing. The continuous printing process enables the filament to be placed precisely along the designated curved and/or angled surface, reducing the “stair-step” effect that some fused deposition modeling processes generate. The non-planar and/or curved tool paths enables the printer to approximate very thin walls (e.g., μm or 10⁻⁶) including those that define the deformable member 104. Because the extrusion rate and tool path is aligned with the walled geometry of the pressure actuated rupture device 100, bonding between adjacent structures of the device is substantially uniform, which improves and strengthens the structural integrity of the pressure actuated rupture device 100 at its extremely small scales and tolerances.

At the micrometer scale, an optional de-binding and sintering process may be applied to the pressure actuated rupture device 100 to remove chemical residue and further fuse the additively manufactured components together, respectively. In some use cases, a very low thermal treatment is applied to preserve the integrity of the micron-scale walls. Table 1 shows some exemplary dimensions of some mediated-pressure transfer system components of the pressure actuated rupture devices 100. The walls are classified by length, and the geometry reflects the shape of the cap 106 and deformable member 104 (e.g., shown in the cylindrical shell and end cap in the drawings), and the containment member 116, which has a right-circular cylindrical shape.

TABLE 1
Some mediated-pressure transfer system component dimensions

| | | Wall | Max | Min | | |
|---|---|---|---|---|---|---|
| Wall | | Thick- | Wall | Wall | Wall | Wall |
| Type | Geometry | ness | O.D. | O.D. | Length | Area |
| short | cylindrical | 160 μm | 6.30 mm | 6.30 mm | 2.81 mm | 55.6 mm² |
| medium | cylindrical | 160 μm | 6.30 mm | 6.30 mm | 5.49 mm | 108.7 mm² |
| tall | cylindrical | 160 μm | 6.30 mm | 6.30 mm | 8.17 mm | 161.7 mm² |

FIG. 5 shows an exemplary receiving device 500 in the form of a stainless-steel irradiation capsule that uses a solid endcap 502 at a distal end, and a pressure actuated rupture device 100 endcap at a proximal end. The endcaps may be monolithically integrated with the rigid capsule housing 504 (e.g., additively manufactured with the capsule), thermally bonded (e.g., via a weld after additively manufactured), and/or rigidly coupled to the receiving device 500. In FIG. 5, the receiving device 500 accommodates varying sample test specimens 506 in a stacked arrangement with spacers and/or gaps separating them.

A broad range of deformable member parameters may determine the elastic limit, yield strength, and/or ultimate strength of the deformable member 104. Exceeding a yield strength level of the receiving device 500 may be based on one or more combinations of those parameters, such as for example, when a ratio of a thickness of the wall or tubular wall of the receiving device 500 over a thickness of the deformable member 104 exceeds a predetermined threshold, and/or when the ratio of the axial length of the receiving device 500 over the axial length of the pressure actuated rupture device 100 exceeds another predetermined threshold, and/or etc.

In FIG. 5, a pressure threshold below the pressure yield strength level at which permanent deformation occurs (P_{yield pressure}) in a receiving device 500 (e.g., the irradiation capsule) in a nuclear reactor established the ultimate strength threshold of the deformable member 104. Through empirical analysis, the yield strength pressure range, P_{yield pressure range} for the irradiation capsule ranged from 6,250-6,000 psi, establishing that the ultimate strength threshold for the deformable member 104 in this use case to be below 6,000 psi.

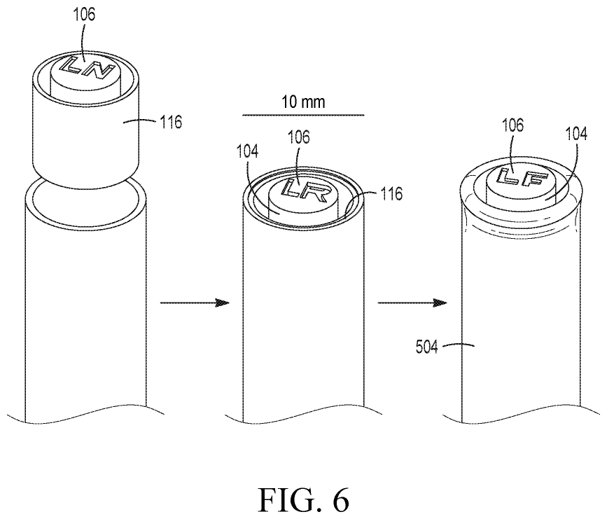

With the deformable member 104 tuned below 6,000 psi and the pressure actuated rupture device 100 assembled and thermally bonded to the irradiation capsule in FIG. 6 or monolithically integrated with the irradiation capsule, the devices were subject to destructive testing to determine the assembled or monolithic device's durability, failure points, and/or safety limits. The test identified the structural weaknesses of the irradiation capsules.

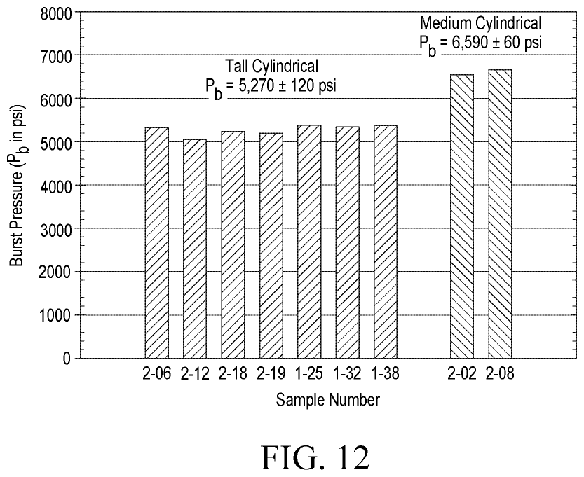

The results showed that the average rupture pressure for the thermally bonded pressure actuated rupture device 100 endcaps occurred in a range below 6,000 psi, specifically, at about 4,764±36 psi, which was about 500 psi less than the average rupture pressure range for the tall monolithic pressure actuated rupture device 100, that ruptured in a range of about 5,270±120 psi as shown in part in FIG. 12. The tall thermally bonded endcaps had a narrower pressure distribution than the monolithic end caps.

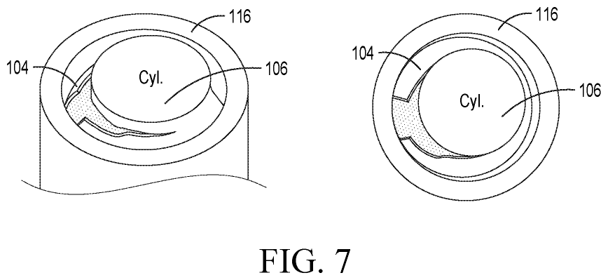

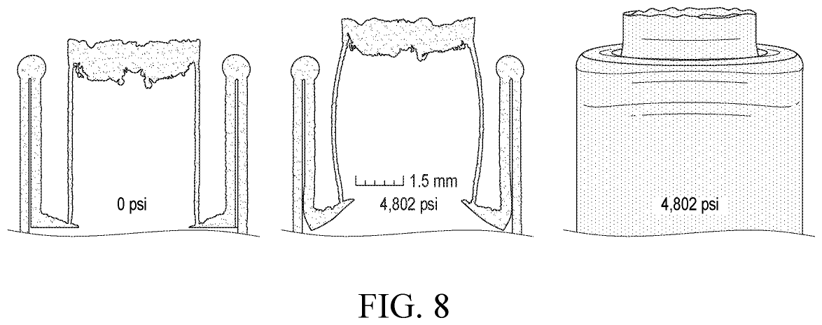

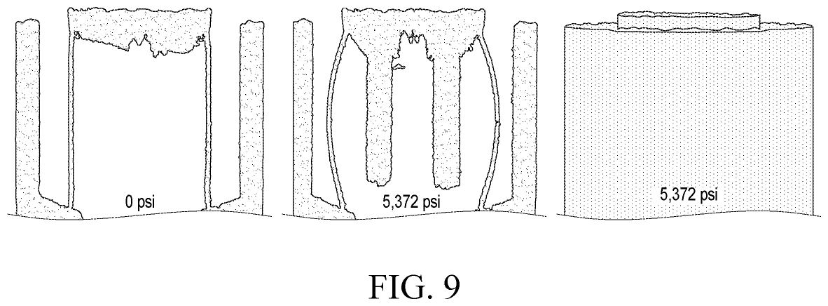

FIGS. 8 and 9 shows a comparisons of the irradiation capsule's failure points under destructive testing of the thermally bonded and monolithically generated irradiation capsules. The thermally bonded pressure actuated rupture device 100 endcaps exhibit a symmetrical barreling and an elongation before rupturing occurred at about 0.8 mm. FIG. 7 shows how the monolithically generated irradiation capsules failed.

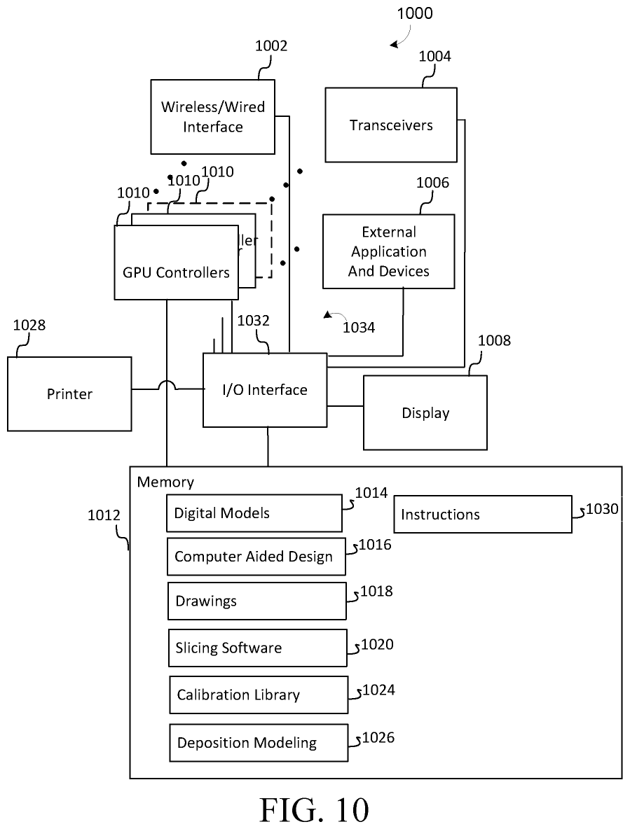

FIG. 10 shows an additive manufacturing system that execute the process flows, functions described herein, shown in FIG. 4, and render the results of FIGS. 7-9. The additive manufacturing systems 1000 comprise one or more central processing units, digital signal processors, and/or graphical processing units 1010, a non-transitory computer-readable medium such as a memory 1012 and/or a cloud services (the contents of which are accessible to the one or more central processing units, digital signal processors, and/or graphical processing units 1010), one or more wireless interfaces 1002, one or more transceivers 1004, one or more external applications and devices 1006, one or more displays 1008, a 3D, 4D, and/or 5D printer 1028, and a physical or wireless network bus 1002 that connects an input and output interface 1032 through an expansion bus 1034. External applications and devices 1006 may include systems and processes that generate the detailed three dimensional digital models and multi-dimensional drawings used by the additive manufacturing, for example, and/or provide the calibration setting to the additive manufacturing fused deposition modeling 1026.

The non-transitory computer-readable medium storing a non-transitory medium encoded with computer-executable instructions executed by one or more central processing units, digital signal processors, and/or graphical processing units 1010 cause the system 1000 to render some or all of the functionality associated with the thermally fused pressure actuated rupture devices 100 or the monolithically integrated pressure actuated rupture devices 100 described that may include the receiving devices 500. The memory 1012 and/or cloud services store CAD software 1016, three dimensional digital models 1014, multi-dimensional drawings 1018, slicing software 1020, calibration parameters 1024, machine readable instructions 1030, and deposition modeling software 1026.

The term cloud and cloud system is intended to broadly encompass hardware and software that enables the systems and processes executed and data to be maintained, managed, and backed up remotely and made available to users over a communication network. In this system, clouds and/or cloud storage provides ubiquitous access to the intrusion detection systems' resources that can be rapidly provisioned over a public and/or a private network at any location. Clouds and/or cloud storage allows for the sharing of resources, features, and utilities in any location to achieve coherence services.

The cloud/cloud services or memory 1012 and/or storage disclosed also retain an ordered listing of executable instructions for implementing the processes, system functions, and features described above in a non-transitory machine or computer readable code. The computer-readable medium may selectively be, but not limited to, an electronic, a magnetic, an optical, an electromagnetic, an infrared, or a semiconductor medium. A non-exhaustive list of examples of a computer-readable medium includes: a portable magnetic or optical disk, a volatile memory, such as a Random-Access Memory (RAM), a Read-Only Memory (ROM), an Erasable Programmable Read-Only Memory (EPROM) or a Flash memory, or a database management system. The cloud/cloud services and/or memory 1012 may comprise a single device or multiple devices that may be disposed on one or more dedicated memory devices or associated with one or more central processing units, digital signal processors, and/or graphical processing units 1010, customized circuit or other similar device.

In this disclosure the term “substantially,” “about,” or “nearly” and forms of those words encompasses a range that is largely in some instances, but not necessarily wholly, that which is specified. They encompass all but a significant amount, such as what is specified or within five to ten percent. In other words, the terms “substantially” or “about” means equal to or at or within five to ten percent of the expressed value. When functions, steps, etc. are “responsive to” or occur “in response to” another function or step, etc., the functions or steps necessarily occur as a result of another function or step, etc. A device or process that is responsive to another requires more than an action (i.e., the process and/or device's response to) merely follow another action. The term “annulet” and forms of this word refers to a plane bounded by two concentric circles where their centers or axes coincide the plane generally encircles a portion of the pressure actuated rupture device 100. The term “elastic limit” level refers to the maximum pressure-induced stress level a material can experience while still returning to its original form once the pressure-induced load pressure is removed. The term “yield strength” level refers to the pressure-induced stress level at which a material begins to under permanent deformation and will no longer return to its original shape after the pressure-induced load is removed. The term “ultimate strength” level refers to the maximum pressure-induced stress level a material can withstand before it begins to fail, burst (e.g., a sudden/without warning fracture or opening due to pressure) and/or rupture (e.g., a structural failure when a material reaches its failure limit). The term “unitary” and “monolithic” and forms of these words refer to an indivisible entity, oneness, and singularity. It refers to a single indivisible entity or component.

The systems that perform the functions disclosed herein may operate without any of the specifically disclosed members or elements, including particular hardware, software, or functionality and may omit some or all of the functions associated with a process step, component, or structure. The systems may also operate in the absence of one or more of these members and/or components, process steps, elements, or any subset of the disclosed functions. Additionally, some systems may incorporate further elements or functionality, in alternative systems.

Further, the various elements and pressure actuated rupture device 100 components, and additive manufacturing process steps described in the systems and processes are regarded as divisible with regard to the individual elements described, rather than inseparable as a whole. In other words, alternative mediated-pressure transfer systems within a pressure actuated rupture device 100 may include any variation, additions and/or combinations of elements, components, and process steps not described herein and may be made, used, or executed in the absence of one or more elements or steps. Such system may also exclude members, elements and/or steps disclosed in the prior art thereby defining alternate systems and methods that exclude those members, elements and/or steps.

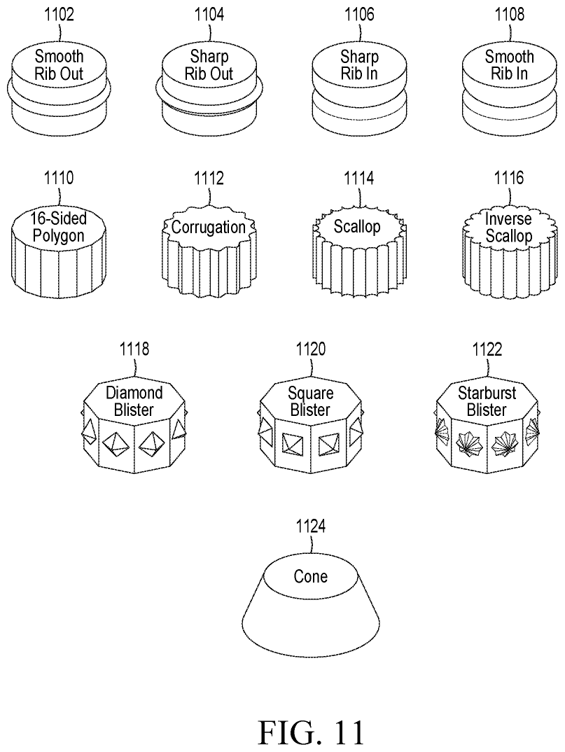

While the disclosed geometry of some of the mediated-pressure transfer system components reflect a cylindrical shape formed by the cap 106 and deformable member 104, alternative caps and alternative deformable members take other geometries as shown in FIG. 11. The shapes of some of these alternative mediated-pressure transfer system components comprise a cylinder-segment with a deformable member having smooth rib out 1102, a cylinder-segment having a deformable member having sharp rib out 1104, a cylinder-segment having a deformable member with a sharp rib in 1106, a cylinder-segment having a deformable member with a smooth rib in 1108, a cylinder-segment having a deformable member formed by a predetermined sided polygon such as sixteen sided polygon 1110, for example, a cylinder-segment having a deformable member formed by corrugation 1112, a cylinder-segment having a deformable member formed by a scallop 1114, a cylinder-segment having a deformable member formed by an inverse scallop 1116, a cylinder-segment having a deformable member having diamond blisters 1118, a cylinder-segment with a deformable member having square blisters 1120, a cylinder-segment with a deformable member having starburst blisters 1122, and a frustrum of a right circular cone 1124 (e.g., a right circular cone bounded by a truncation plane that serves as a cap parallel with its base).

In these alternative mediated-pressure transfer system components, the geometries of alternative containment members, alternative regulator zones, and alternative containment zones conform to the shape of the alternative caps, respectively, and alternative deformable members, respectively. They take their geometry. This means that the shapes alternative containment members, alternative regulator zones, and alternative containment zones are defined to match the contours of the alternative caps and deformable members they interface. It further means that the dimensions are structured to provide a single-use, non-reclosing safety fuse-like function of their deformable members that prevents catastrophic failure of the receiving device 500 they couple and contain the initial debris within their containment zones. In short, the alternative components adopt geometries that conform to their adjoining structures that ensure a proper fit, pressure-induced load transfer, and distribution of pressure that exceeds the yield strength of their receiving devices meaning it is lower than the yield strength level of the receiving devices they couple.

Further, the regional volume and distribution of the enclosed alternative regulator zone and the partially enclosed alternative containment zone of these alternative systems may vary by size, distribution, and other dimensions to the rupture or the burst characteristics of their alternative deformable walls. For example, in an exemplary alternative frustrum of a right circular cone 1124, the separation between the base of the frusto-conical deformable member and the base of its containment member may be greater than at the frusto-conical truncation cap and a top portion of a containment member to facilitate a deformation characteristics that ensure a burst or a rupture of the frusto-conical deformable member near the base. Thus, the alternative containment zone and/or alternative regulator zones may comprise irregular non-uniform volumes that vary within the areas of each of their respective zones so that they accommodate or facilitate the failure of their deformable members at the yield strength levels of their receiving devices at any portion of their deformable members.

In Table 2, exemplary wall lengths of an alternative frustrum of a right circular cone 1124 classified by length, and geometry reflects the shape of an alternative cap and alternative deformable member (e.g., shown as a frusto-conical shell (“Cone”) in FIG. 11).

TABLE 2
Some alternative mediated-pressure transfer system component
dimensions of a frustrum of a right circular cone.

| | | Wall | Max | Min | | |
|---|---|---|---|---|---|---|
| Wall | | Thick- | Wall | Wall | Wall | Wall |
| Type | Geometry | ness | O.D. | O.D. | Length | Area |
| short | conical | 160 um | 8.72 mm | 6.47 mm | 2.81 mm | 69.9 mm² |
| medium | conical | 160 μm | 8.72 mm | 6.47 mm | 5.49 mm | 126.9 mm² |
| tall | conical | 160 μm | 8.72 mm | 6.43 mm | 8.17 mm | 188.5 mm² |

In another alternative the actuated rupture device 100 in the form of a rupture cap couples a receiving device 500 in the form of a tubular housing 504 having an open end with a solid wall, a first thickness, a first diameter, and a first axial length. The rupture cap is assembled coaxially onto the housing 504 of the receiving device 500 to close the open end. The rupture cap comprises a solid wall with a second thickness that is less than the housing wall thickness and a second axial length that is shorter than the housing length. The rupture cap has a fixed or a variable diameter that is smaller than the housing diameter so that it is received within the housing 504 when assembled. The rupture cap wall is connected at its inner end to the housing wall. The relative dimensions, specifically the ratio of the housing wall thickness to the rupture cap wall thickness and the ratio of the housing length to the rupture cap length are selected so that when pressure builds within the rupture cap, some of the rupture cap's wall bursts or ruptures before the housing wall of its receiving device undergoes a permanent deformation or a swelling. In some systems, solid wall of the rupture cap couples an inner end of the housing 504 of the receiving device through a base. The solid wall of the rupture cap has a cylindrical shape, and the second diameter comprises a fixed value.

A pressure actuated rupture device 100 mediates the dangers of over-pressurization by providing controlled and predictable failure points that actuate before pressures reach levels that would permanently damage receiving devices 500 and surrounding systems. Instead of allowing pressure to build until seals fail, fittings leak, or vessel walls deform and burst, the device is configured to rupture at a pre-tuned ultimate strength threshold level that is below the yield strength threshold level of the receiving device 500. Other alternative devices are configured to rupture at a pre-tuned ultimate strength threshold level that is below an elastic limit threshold level of the receiving device 500. When those levels occur, the device immediately relieves excess pressure without permanent deformations in the receiving devices 500. The device converts an uncontrolled and potentially catastrophic over-pressure event into a managed pressure release event.

By relieving pressure before structural limits are reached, the pressure actuated rupture device 100 also protects critical components from deformation and the damage that occurs when containment is not restricted. In nuclear operations, the pressure actuated rupture device 100 can reduce the risk that temporary and permanent vessel-wall deformation will obstruct coolant flow and contribute to thermal runaway conditions. In hydraulic and industrial systems, it can reduce the chance of a high-velocity fluid release, which may lead to progressive failures of connected components. More broadly, the device mitigates chain-reaction failures by releasing excess pressure before it cascades and damages other devices and systems.

Further, the disclosed system improves safety by detecting over-pressure conditions passively through the pressure itself and responds immediately without requiring operator intervention or advance warning. The pressure actuated rupture device 100 preserves containment integrity, protects nearby structures and equipment, and reduces the likelihood of severe damage or injury.

Other systems, methods, features, and advantages will be, or will become, apparent to one with skill in the art upon examination of the figures and detailed description. It is intended that all such additional systems, methods, features, and advantages be included within this description, are within the scope of the disclosure, and be protected by the following claims.

1. A pressure actuated rupture device, comprising:
a cap comprising a right-circular disc having a predetermined stiffness that resists deformation and comprises a load-bearing structure; the cap resists an upward deformation and distributes a plurality of pressure-induced forces sourced by a working fluid that engages the cap;
a vertical element and a buttress element comprising a mandrel-structure having a predetermined stiffness that couples the cap to a base;
a deformable member comprising a cylindrical side wall have a tunable yield strength threshold and a tunable ultimate strength threshold that establish when the cylindrical side wall begins to undergo a permanent deformation and when the cylindrical side wall ruptures, respectively;
the buttress element couples the vertical element to the base, the buttress element having an acute incline surface unitary with a surface of the vertical element structured to convert a plurality of axial forces into a plurality of lateral surfaces that bias the deformable member; and
a regulator zone bounded between a length of the deformable member and the surface of the vertical element and the acute incline surface of the buttress element; the regulator zone forming a right-cylindrical annulet zone encircling the vertical element and the buttress elements;
where the deformable member, the buttress element, and the regulator zone are concentric about a common axis of symmetry; and
where a thickness of the cylindrical side wall of the deformable member is established by a yield strength level of a housing of a receiving device.

2. The pressure actuated rupture device of claim 1, further comprising a containment zone that separates a structural containment member that couples the deformable member through the base.

3. The pressure actuated rupture device of claim 2, where the containment zone is concentric about the common axis of symmetry.

4. The pressure actuated rupture device of claim 3, where the structural containment member is concentric about the common axis of symmetry.

5. The pressure actuated rupture device of claim 4, where the containment member contains a failure debris within the containment zone when a rupture occurs in the deformable member.

6. The pressure actuated rupture device of claim 1, where the buttress element comprises a stepped-up rigid structural support.

7. The pressure actuated rupture device of claim 1, where the deformable member comprises a displacement multiplier when a yield strength threshold of the deformable member is exceeded, which alters a pressure induced transfer though the regulator zone.

8. The pressure actuated rupture device of claim 1, where the deformable member is structured to irreversibly rupture before a portion of the receiving device undergoes a permanent deformation.

9. The pressure actuated rupture device of claim 1, where a burst pressure or a rupture pressure of the cylindrical side wall of the deformable member is established by a thickness of the cylindrical side wall, an inner diameter of the cylindrical side wall, a wall length of the cylindrical side wall, and a plurality of material properties of the cylindrical side wall.

10. The pressure actuated rupture device of claim 1, where the cylindrical side wall ruptures when a ratio of a thickness of a tubular wall of the receiving device to a thickness of the deformable member exceeds a predetermined threshold.

11. The pressure actuated rupture device of claim 1, where the cylindrical side wall ruptures when a ratio of an axial length of the receiving device to the axial length of the pressure actuated rupture device exceeds a predetermined threshold.

12. The pressure actuated rupture device of claim 1, where a thickness of the deformable member is a millionth of a meter.

13. The pressure actuated rupture device of claim 1, where the cap, the vertical element, and the deformable member is monolithically integrated with the receiving device to form a single integrated structure.

14. The pressure actuated rupture device of claim 1, where the base is thermally fused to the receiving device.

15. A sample-holding capsule configured to burst in a controllable manner when experiencing a pressure buildup within the capsule, the capsule comprising:
a housing having a tubular shape and a solid housing wall of a first thickness, a first diameter, and a first axial length, wherein the housing has an open end; and
a rupture cap configured to be assembled coaxially to the housing to close the open end, the rupture cap having a solid cap wall of a second thickness that is less than the first thickness and a second axial length that is less than the first axial length, where the solid cap wall has a fixed or a variable second diameter that is less than the first diameter to allow the solid cap wall to be received by the housing; when the rupture cap is assembled to the housing, an inner end of the solid cap wall couples the housing wall;
where a predetermined parameter combination that includes a first ratio of the first thickness to the second thickness and a second ratio of the first axial length to the second axial length ratio is configured so that a pressure buildup within the rupture cap when the rupture cap couples the housing causes the solid cap wall to burst or to rupture before causing the solid housing wall to plastically yield and irreversibly swell.

16. A sample-holding capsule of claim 15, further comprising a solid wall that couples an inner end of the housing through a base.

17. A sample-holding capsule of claim 16, where the solid wall has a cylindrical shape and the second diameter comprises a fixed value.

18. A pressure actuated rupture device, comprising:
a cap comprising a disc having a predetermined stiffness that resists deformation and comprises a load-bearing structure; the cap distributes a plurality of pressure-induced forces sourced by a working fluid that engages the cap;
a vertical and a buttress element comprising a mandrel-structure couples the cap to a base;
a deformable member comprising a cylindrical side wall have a tunable yield strength threshold and a tunable ultimate strength threshold that establish when the cylindrical side wall begins to undergo a permanent deformation and when the cylindrical side wall bursts or ruptures, respectively;
the buttress element couples the vertical element to the base, the buttress element having an incline surface monolithically integrated with a surface of the vertical element to form a single integrated structure that converts a plurality of axial forces into a plurality of lateral surfaces that bias the deformable member;
a regulator zone bounded between a length of the deformable member and the surface of the vertical element and the incline surface of the buttress element; the regulator zone forming a right-cylindrical annulet zone encircling the vertical and the buttress elements; and
a containment zone that separates a structural containment member that couples the deformable member through the base;
where one or more of a thickness, a width, and a length of the cylindrical side wall of the deformable member is established by a yield strength of a receiving device that couples the base.

19. The pressure actuated rupture device of claim 18, where the deformable member, the vertical element, the buttress element, and the regulator zone are concentric.

20. The pressure actuated rupture device of claim 18, where the thickness of the deformable member is in a micron scale and is free of a stair-step effect of a fused deposition modeling.

21. The pressure actuated rupture device of claim 20, where the thickness of the deformable member is about 160 micrometers.
